(19) United States
(12) Patent Application Publication
(10) Pub. No.: US 2009/0017269 A1
(43) Pub. Date: Jan. 15, 2009

(54) Camouflage articles and method of making and using same

(76) Inventor: Steve Johnson, Church Hill, TN (US)

Correspondence Address: GARDNER GROFF GREENWALD & VILLANUEVA. PC, 2018 POWERS FERRY ROAD, SUITE 800, ATLANTA, GA, 30339, US

(21) Appl. No.: 11/804,055

(22) Filed: May 17, 2007

Related U.S. Application Data
(63) Continuation-in-part of application No. 11/636,906, filed on Dec. 12, 2006, now abandoned.

(51) Int. Cl. F41H 3/00; G06K 9/36

(52) U.S. Cl. 428/195.1; 382/284

(57) ABSTRACT

The present invention relates to a camouflage pattern comprising naturally occurring objects in combination with non-naturally occurring objects such as a logo, trademark, brand, name, symbol or other designation. In order to make such a camouflage pattern a two-dimensional layout of a collage or combination of images of a naturally occurring object and a logo, brand, or other designation, or a pattern of logos, brands or other designations is obtained. Then the composite image is digitized to yield a two-dimensional digital data set. The latter then is processed in a computer to produce the desired camouflage pattern comprising both elements of naturally occurring articles and the selected non-natural elements comprising a logo, brand, or other designation or combinations thereof. The resulting camouflage pattern then may be transferred to a useful article such as clothing, for example, or to any other of the myriad articles where camouflage patterns are desired and used.

### CROSS-REFERENCE TO RELATED APPLICATION

This application is a Continuation-In-Part of my copending Non-Provisional application Ser. No. 11/636,906, filed Dec. 12, 2006.

### BACKGROUND OF THE INVENTION

1. Field of the Invention

The present invention relates generally to camouflage articles, and, more particularly, to camouflage articles that are derived from a combination of natural objects and non-natural objects or designations.

2. Description of the Prior Art

The use of camouflage is well known in the arts of hunting and in the military arts. For example, camouflage cloth is used in the fabrication of clothing. Also, camouflage patterns are painted on the exterior surfaces of vehicles and buildings and used on the surface of articles such as firearms and binoculars and optical scopes. Camouflage patterns often are derived from images of naturally occurring objects such as animals, insects, birds, tree branches or bark, leaves and other foliage, or combinations of such objects. For example, in U.S. Pat. No. 5,773,101 (Sanders), there is disclosed a camouflage pattern comprising three-dimensional folds extending from the plane of an underlying sheet or surface. This patent suggests (Col. 7, lines 19-20) natural images such as woods, tree bark, branches, brush plants, and grass may be photographic images transferred to the sheet. In my prior co-pending application Ser. No. 10/777,953, filed Feb. 12, 2004 (attorney docket 4023M), I disclose various camouflage patterns derived from animals, insects birds or the like, or parts thereof (e.g. moth wings) and the method of making such patterns by capturing a photographic image of the animal part, digitizing that image, and processing the image in a computer using known image processing software to produce a camouflage pattern capable of being transferred to an article or article surface.

In still another prior co-pending application Ser. No. 11/155,115, filed Jun. 17, 2005 (attorney docket 4054M), I disclose a three-dimensional camouflage pattern derived from naturally occurring patterns of tree bark or the like. I further disclose that the tree bark camouflage pattern may be made by capturing a two-dimensional image of the natural object and digitizing the image in a computer which contains known software to convert the two-dimensional digitized data into a corresponding three-dimensional digitized set which, in turn, is used to operate a laser to cut the three-dimensional pattern onto a surface of a useful article (e.g. rifle butt stock), or to make a reverse mold of the digitized three-dimensional pattern and then mold three-dimensional objects therefrom corresponding to the three-dimensional naturally occurring pattern.

The disclosure of the foregoing U.S. Pat. No. 5,773,101 (Sanders), and the specification of each of my prior co-pending U.S. patent applications hereby is incorporated herein and made part of this specification by this reference.

Camouflage patterns have become so widespread and popular they are even used throughout the world of fashion to ornament clothing, shoes, bags, hats and so on. Also wildly popular in the fashion world is the use of logos, trademarks, brands, emblems and other designations to ornament clothing and articles. Heretofore, such designations have not been used as camouflage or as elements in a camouflage pattern. It would be desirable if a person's favorite logo or brand was used to embellish a camouflage pattern because many individuals take enormous pride and satisfaction in associating with such logos or brands.

### BRIEF SUMMARY OF THE INVENTION

To achieve the foregoing and other advantages, the present invention, briefly described, provides a camouflage pattern comprising naturally occurring objects in combination with non-naturally occurring objects such as a logo, trademark, brand, name, symbol or other designation. In order to make such a camouflage pattern, the methods employed in either of my prior co-pending applications preferably may be used. Thus, a two-dimensional layout of a collage or combination of images of a naturally object and a logo, brand, or other designation, or a pattern of logs, brands or other designations is obtained. Then the composite image is digitized to yield a two-dimensional digital data set. The latter then is processed in a computer to produce the desired camouflage pattern comprising both elements of naturally occurring articles and the selected non-natural elements comprising a logo, brand, or other designation or combinations thereof. If desired, in accordance with the present invention, at least some of the naturally occurring elements of the camouflage article can be color coded or coordinated to correspond top the color or colors of the non-naturally occurring object or objects. The resulting camouflage pattern then may be transferred to a useful article such as clothing, for example, or to any other of the myriad articles where camouflage patterns are desired and used.

The above brief description sets forth rather broadly the more important features of the present invention in order that the detailed description thereof that follows may be better understood, and in order that the present contributions to the art may be better appreciated. There are, of course, additional features of the invention that will be described hereinafter and which will be for the subject matter of the claims appended hereto.

In this respect, before explaining a number of preferred embodiments of the invention in detail, it is understood that the invention is not limited in its application to the details of the construction and to the arrangements of the components set forth in the following description or illustrated in the drawings. The invention is capable of other embodiments and of being practiced and carried out in various ways. Also, it is to be understood, that the phraseology and terminology employed herein are for the purpose of description and should not be regarded as limiting.

As such, those skilled in the art will appreciate that the conception, upon which disclosure is based, may readily be utilized as a basis for designing other structures, methods, and systems for carrying out the several purposes of the present invention. It is important, therefore, that the claims be regarded as including such equivalent constructions insofar as they do not depart from the spirit and scope of the present invention.

It is therefore an object of the present invention to provide a new and improved camouflage article and method which has all of the advantages of the prior art and none of the disadvantages.

It is another object of the present invention to provide a new and improved camouflage article and method which may be easily and efficiently manufactured and marketed.

It is a further object of the present invention to provide a new and improved camouflage article and method which is of durable and reliable construction.

An even further object of the present invention is to provide a new and improved camouflage article and method which is susceptible of a low cost of manufacture with regard to both materials and labor, and which accordingly is then susceptible of low prices of sale to the consuming public, thereby making such camouflage article and method available to the buying public.

Still yet a further object of the present invention is to provide a new and improved camouflage article and method which provide camouflage articles having combined naturally occurring elements and non-naturally occurring elements.

Still another object of the present invention is to provide a new and improved camouflage article and method that provide a camouflage article that includes elements of non-naturally occurring objects and wherein the non-naturally occurring object is a selected logo, brand, trademark, symbol or other designation, or a combination thereof.

Yet still another object of the present invention is to provide a new and improved camouflage article and method that provide a camouflage article that includes elements of naturally occurring articles and non-naturally occurring objects, wherein the non-naturally occurring object is a selected logo, brand, trademark, symbol or other designation, or a combination thereof, and wherein at least some of the naturally occurring elements of the camouflage article are color coded or coordinated to correspond top the color or colors of the non-naturally occurring object or objects.

These together with still other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

These together with still other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The invention will be better understood and the above objects as well as objects other than those set forth above will become more apparent after a study of the following detailed description thereof. Such description makes reference to the annexed drawing wherein:

FIG. 1 is a facsimile of a camouflage pattern produced in accordance with the invention and wherein the pattern comprises an image of a non-naturally occurring element labeled “Logo” against a background of images of naturally occurring objects.

FIG. 2 is a facsimile of an alternatively preferred camouflage pattern produced in accordance with the invention and wherein the pattern comprises a plurality of images of non-naturally occurring elements each labeled “Logo” and each having a different spatial orientation with respect to the others against a background of images of naturally occurring objects.

FIG. 3 is a front view of a person wearing a hat and clothing bearing a camouflage pattern which could be made in accordance with the method of making camouflage articles of the invention.

FIG. 4 includes a side view of a weapon, a perspective view of eyewear, and a perspective view of binoculars, each of which bears a camouflage pattern which could be made in accordance with the principles of the invention.

FIG. 5 is a facsimile of an alternatively preferred camouflage pattern produced in accordance with the invention and wherein the camouflage pattern comprises a plurality of images of naturally occurring elements color coded or coordinated to correspond to the colors of a non-naturally occurring object such as a selected logo, brand, trademark, symbol or other designation, or a combination thereof.

FIG. 6 is a perspective view of an article of clothing in the form of a baseball cap showing the camouflage pattern of FIG. 5 combined with a logo where the color or colors of the logo are coordinated with the color or colors of the camouflage pattern.

### DESCRIPTION OF THE PREFERRED EMBODIMENT

With reference to the drawings, a new and improved article of camouflage and method of making such camouflage articles embodying the principles and concepts of the present invention will be described.

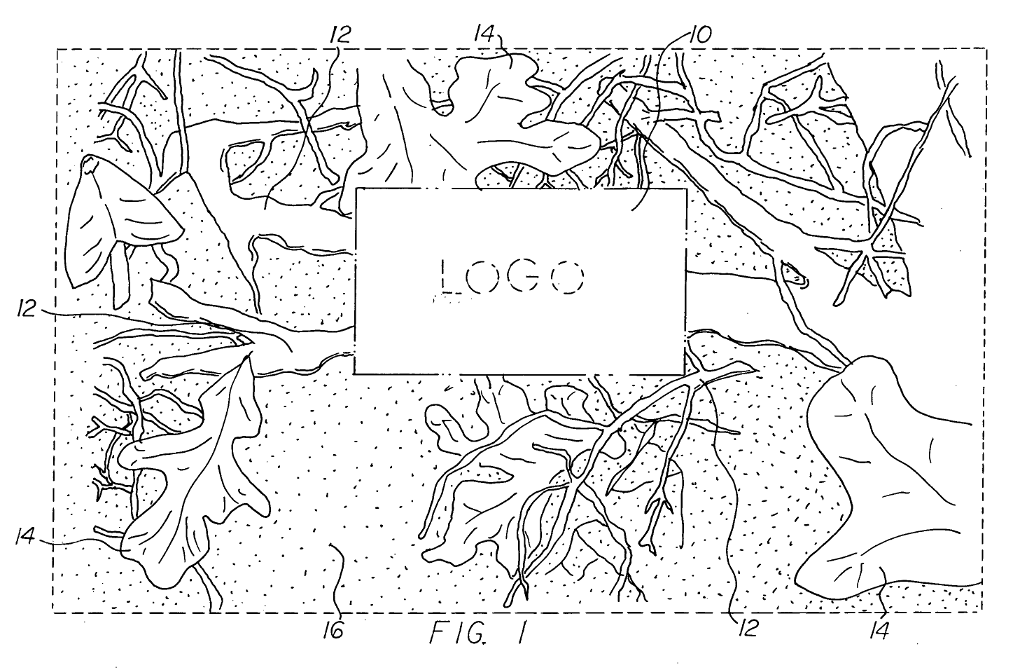

Turning now to FIG. 1, there is shown a facsimile of a portion of a camouflage pattern produced in accordance with the invention and wherein the pattern comprises an image of a non-naturally occurring element labeled “Logo” and denoted by reference sign 10 reposing against a background of images of naturally occurring objects. The naturally occurring elements may include tree branches 12 and leaves 14. If desired a mottled background of a desired color or colors indicated by reference sign 16 may be used to enhance the camouflage or concealment effect of the pattern. The logo, trademark or brand 10 may comprise any desired designation such as without limitation the name or symbol of a particular sports team or sports team mascot, government organization, religious affiliation, college, university, or other school, corporate identity, fashion designer, flag, or other emblem, or any other known visual designation of choice.

It will be appreciated that the logo or non-naturally occurring visual image component 10 may be used alone, in any size, and in any number or repetitions throughout the pattern as long as the logo or non-naturally occurring visual image component 10 is integrated into the camouflage pattern and becomes part and parcel thereof. The camouflage pattern of the present invention therefore is to be readily distinguished from a camouflage pattern merely having a manufacturer's label somewhere on the camouflage pattern or article.

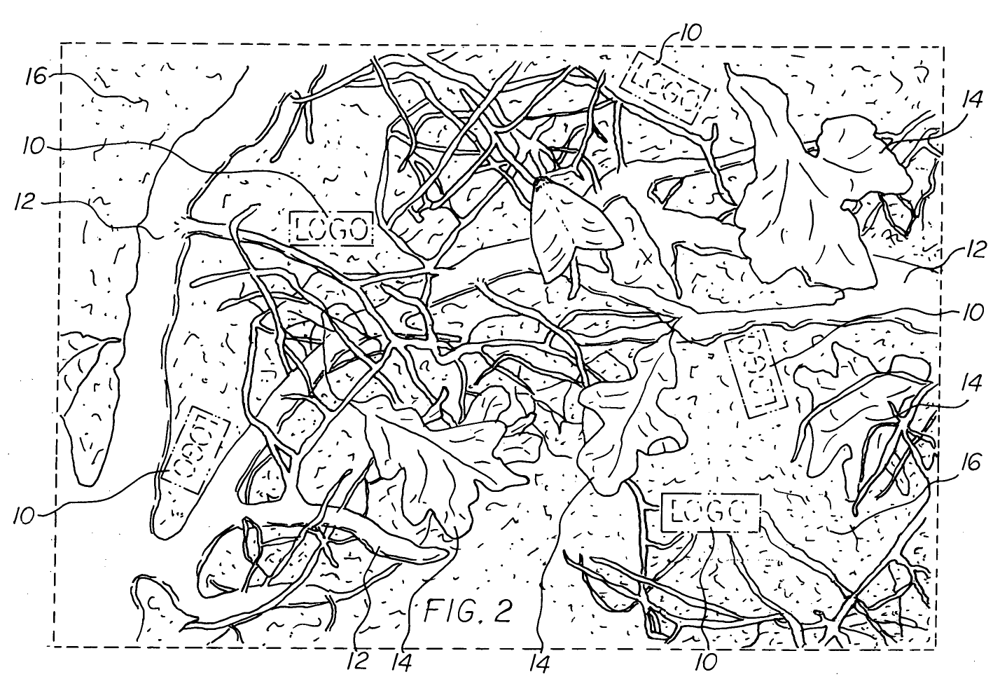

Thus, as shown in the alternatively preferred arrangement of FIG. 2, the logo element 10 may be dispersed throughout the pattern and have different spatial orientations so that it blends with the pattern of naturally occurring elements 12 and 14 to form a pattern within a pattern. It will further be appreciated that the logo image 10 may have different colors or the actual color associated normally therewith. For example, when selecting the well-known “T” logo of the University of Tennessee to use in accordance with the present invention, the same intense orange color normally used with that logo may be used.

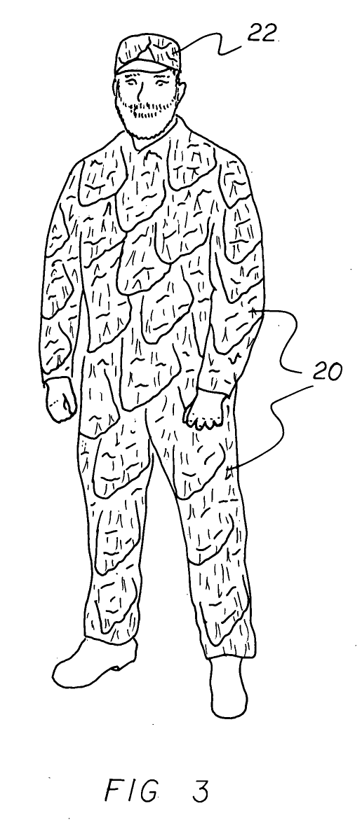

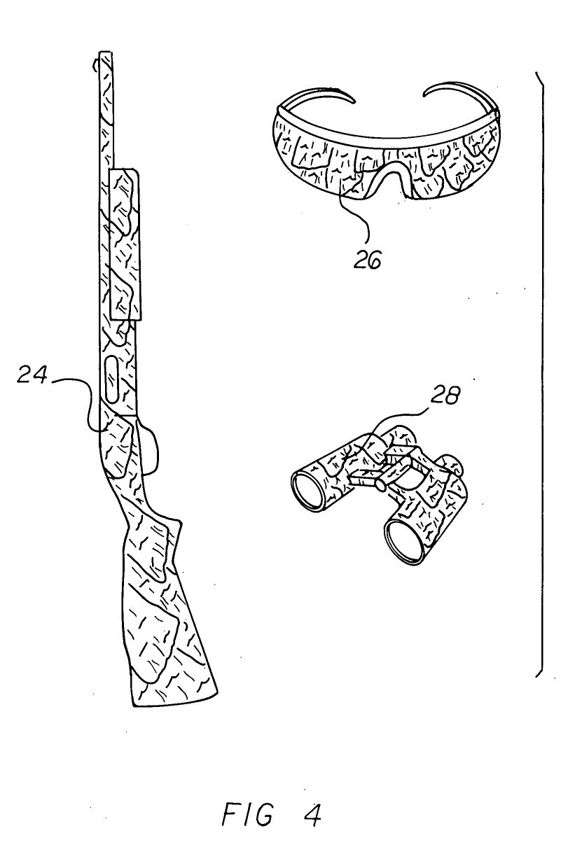

Although the background elements 12 and 14 comprise tree branches and leaf patterns, this merely is to illustrate the preferred embodiment of the invention. Any image of a known natural object may be employed instead. For example as shown in FIGS. 3 and 4 the camouflaged articles 24, 26, and 28 therein display the “moth wing” camouflage pattern disclosed in my prior application Serial No. Ser. No. 10/777,953, filed Feb. 12, 2004. It is contemplated that the logo elements 10 shown in FIGS. 1 and 2 may be added to the camouflage patterns on the rifle 28, the eyeglasses 26 and the binoculars 28 in accordance with the teachings herein.

In order to make the camouflage pattern of FIGS. 1 and 2 the following method steps may be employed. First a two-dimensional image of the selected logo, trademark, brand or other symbol 10 is obtained. Next the image of the selected naturally occurring elements 12 and 14 against a suitable background 16 (if desired) is obtained. Next, the images are combined in the desired manner (FIGS. 1 and/or 2). Then the combined two-dimensional image is digitizing and transferred to a computer system which includes known image processing software. Finally, the digitized captured image with the image processing software is processed to produce an article which bears the processed captured image, such that the article bears a camouflage pattern comprising images of both naturally occurring objects and the desired selected logo or logos or non-naturally occurring objects.

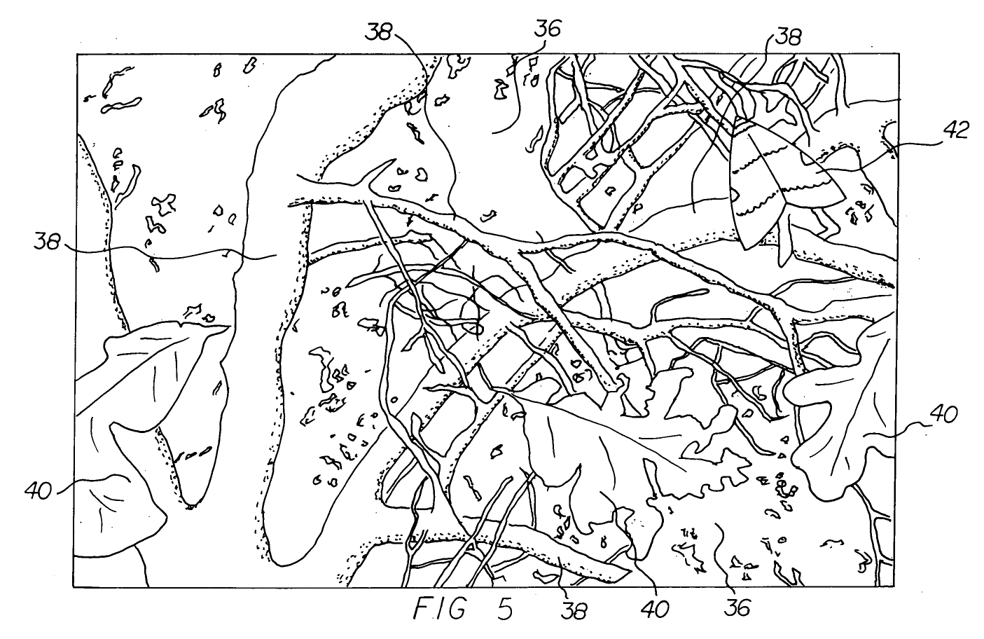

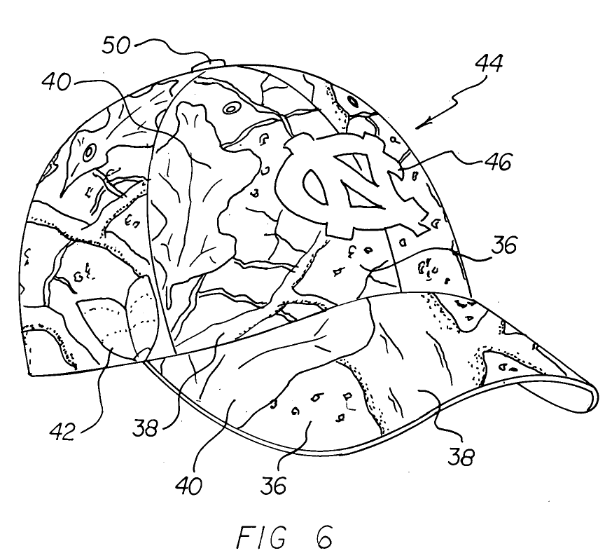

Turning now to FIGS. 5 and 6, an alternatively preferred embodiment of the present invention will now be described. In this alternative embodiment, and in accordance with the present invention, there is provided a camouflage article that includes elements of naturally occurring articles and non-naturally occurring objects, wherein the non-naturally occurring object is a selected logo, brand, trademark, symbol or other designation, or a combination thereof, and wherein at least some of the naturally occurring elements of the camouflage article are color coded or coordinated to correspond top the color or colors of the non-naturally occurring object or objects. Thus, as shown in FIG. 5, the camouflage pattern thereof comprises a background field 36 of a first desired color and naturally occurring elements which for example, may include tree branches 38, leaves 40 and insects 42, and wherein at least one of the elements comprising the tree branches, leaves or insects are of a second color. In accordance with the invention, the first and second colors are coded or coordinated to correspond to the “school or team colors” so-to-speak corresponding to the logo or other non-naturally occurring object with which the camouflage pattern of FIG. 5 is to be used.

The foregoing arrangement is shown in FIG. 6 wherein the baseball cap generally represented by reference sign 44, includes a non-naturally occurring object 46 comprising, by way of illustration, the logo of North Carolina University, which logo has a color corresponding to the particular “colors” of that institution (e.g. either “blue,” “white,” or both) and wherein the camouflage pattern imprinted or otherwise disposed on the fabric panels making up the cap 44 has a background field of a first color (e.g. “blue”) and tree branch elements of a second color (e.g. “white”). If desired, the leaf elements may be of a third color such as for example, various shades of “brown or tan” to provide an attractive contrasting element or to improve the camouflage effect or appearance of the ensemble. To further enhance the appearance of cap 44, the fabric panels making up the cap can be cut from the fabric sheet bearing the pattern of FIG. 5 and randomly oriented relative to each other before being stitched or sewn together so that the various panels thereof do not present a continuous pattern. This attractive, unique arrangement is clearly further illustrated in FIG. 6. Additionally, if desired, the familiar decorative button 50 on top of the cap may be color coordinated with either the first or second color.

It will be appreciated that the camouflage pattern of FIG. 5 essentially may be made by the same method used to make the camouflage patterns of FIGS. 1 and 2 as described above with the exception that the logo element can be fabricated separately and then subsequently attached as by sewing or in other known ways.

The articles provided by the method of making camouflage articles of the invention can be made in sheet form from inexpensive and durable cloth, plastic or paper materials. Alternatively, the unique camouflage pattern of the present invention may be applied to a surface by painting, or engraving or other known surface treating or ornamenting methods.

The foregoing detailed description is considered as illustrative only of the principles of the invention. Numerous modifications and changes will readily occur to those skilled in the art and therefore, it is not desired to limit the invention to the exact construction and operation shown and described. For example, numerous other and different camouflage patterns may be produced using the method of the present invention by adding other pictorial image elements to the pattern. Accordingly, all suitable modifications and equivalents falling within the broad scope of the subject matter described above may be resorted to in carrying out the present invention.

Finally, it will be appreciated that the purpose of the annexed Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. Accordingly, the Abstract is neither intended to define the invention or the application, which only is measured by the claims, nor is it intended to be limiting as to the scope of the invention in any way.

What is claimed is:

1. An article comprising a camouflage pattern, wherein said camouflage pattern comprises at least one image of a naturally occurring object and at least one image of a non-naturally occurring object, and wherein the at least one images are integrated to form the camouflage pattern.

2. The article of claim 1, wherein the at least one image of the non-naturally occurring object is a two-dimensional designation.

3. The article of claim 2, wherein the two-dimensional designation is a logo, trademark, brand, or other designation.

4. The article of claim 2, wherein the logo, trademark, brand, or other designation is the name or symbol of a particular sports team or sports team mascot, government organization, religious affiliation, college, university, or other school, corporate identity, fashion designer; flag, or other emblem.

5. The apparatus of claim 3 wherein said camouflage pattern comprises a plurality of naturally occurring objects forming a background pattern, and said least one image of a logo, trademark, brand, or other designation is repeated and dispersed throughout said background pattern to form a pattern within a pattern.

6. The article of claim 1 wherein the logo, trademark, brand, or other designation is the name or symbol of a particular sports team or sports team mascot, government organization, religious affiliation, college, university, or other school, corporate identity, fashion designer; flag, or other emblem, and has a particular color associated therewith, and wherein said at least one image of a non-naturally occurring object has the same particular color.

7. The article of claim 6 wherein said camouflage pattern comprises a plurality of naturally occurring objects forming a background pattern, said naturally occurring objects comprising tree branches and leaves, and at least some of said tree branches are of said same particular color.

8. The article of claim 6 wherein said camouflage pattern comprises a plurality of naturally occurring objects forming a background pattern, said naturally occurring objects comprising tree branches and leaves imposed against a background field, and at least a portion of said background field has said same particular color.

9. A method for making a camouflage pattern, said method comprising:
(a) obtaining one or more digital images of at least one naturally occurring object,
(b) obtaining one or more digital images of at least one non-naturally occurring object.
(c) creating a pattern with said images being combined.

10. The method of claim 9, which further comprises contacting at least one article with said pattern or placing said pattern on at least one article or covering all or a portion of at least one article with said pattern.

11. The method of claim 9, wherein said pattern is emplaced on at least one article.

12. The method of claim 9, wherein said naturally occurring object is selected from the group comprising tree branches, leaves, or insects.

13. The method of claim 12, wherein said non-naturally occurring object is selected from the group comprising a logo, trademark, name or other symbol or designation.

14. The method of claim 13, wherein said logo, trademark, name or other symbol or designation is a name or symbol of a particular sports team or sports team mascot, government organization, religious affiliation, college, university, or other school, corporate identity, fashion designer, flag, or other emblem.

15. A method for making a camouflaged article, said method comprising:
(a) obtaining one or more digital images of at least one naturally occurring object,
(b) transferring said image to a sheet to create a camouflage pattern on said sheet,
(c) applying said camouflage pattern on said sheet to an article,
(d) adding a logo, trademark, name or other symbol or designation is a name or symbol of a particular sports team or sports team mascot, government organization, religious affiliation, college, university, or other school, corporate identity, fashion designer, flag, or other emblem, to said article.

16. The method of claim 15 wherein said camouflage pattern has elements chosen from the group consisting of tree branches, leaves or insects making up the elements thereof, and wherein said logo, trademark, name or other symbol or designation is a name or symbol of a particular sports team or sports team mascot, government organization, religious affiliation, college, university, or other school, corporate identity, fashion designer, flag, or other emblem, is associated with a first particular color, and
wherein said step (b) comprises the further step of creating a camouflage pattern wherein at least one of said elements thereof is of the same color as said particular color.
